(19) United States
(12) Patent Application Publication
(10) Pub. No.: US 2026/0247066 A1
(43) Pub. Date: Aug. 20, 2026

(54) Open-Ear Headphone with Energy-Directing Nozzle

(71) Applicant: Bose Corporation, Framingham, MA (US)

(72) Inventors: Ryan C. Struzik, Hopkinton, MA (US); Michael James Daley, Shrewsbury, MA (US); Joel Henry Miller, Westborough, MA (US)

(21) Appl. No.: 19/056,048

(22) Filed: Feb. 18, 2025

(51) Int. Cl. H04R 1/32; H04R 1/10

(52) U.S. Cl. CPC H04R 1/323; H04R 1/1016; H04R 1/1091

(57) ABSTRACT

Aspects include open-ear headphones. In certain cases, an open-ear headphone includes: a body having: a first portion configured to pass over an outer side of at least one of an anti-helix, a helix, or a lobule of the outer ear, and a second portion configured to be located behind the outer ear; and an acoustic module coupled to the body and configured to be located at least in part in a cavum conchae of an outer ear of a user, the acoustic module having an acoustic transducer and a nozzle including a first sound-emitting opening, where the nozzle is an extension of the acoustic module that directs acoustic energy from the first sound-emitting opening toward an ear canal entrance of the user.

### BACKGROUND

The disclosure relates generally to wearable audio devices. More particularly, the disclosure relates to headphones such as open-ear headphones.

### SUMMARY

Various implementations are directed to headphones (e.g., earphones such as earbuds). In certain cases, a headphone includes an ear cuff and an acoustic package configured to deliver sound to the ear canal region.

In particular cases, an open-ear headphone includes: a body having: a first portion configured to pass over an outer side of at least one of an anti-helix, a helix, or a lobule of the outer ear, and a second portion configured to be located behind the outer ear; and an acoustic module coupled to the body and configured to be located at least in part in a cavum conchae of an outer ear of a user, the acoustic module having an acoustic transducer and a nozzle including a first sound-emitting opening, wherein the nozzle is an extension of the acoustic module that directs acoustic energy from the first sound-emitting opening toward an ear canal entrance of the user.

All examples and features mentioned below can be combined in any technically possible way.

In certain cases, the extension is at least approximately 1 millimeter (mm) long, approximately 2 mm long, approximately 3 mm long, or approximately 4 mm long as measured from a distal end of the acoustic module.

In particular implementations, the extension is a fixed extension of the acoustic module.

In certain cases, the first sound-emitting opening is configured to be spaced from and proximate the user's ear canal opening.

In certain cases, the nozzle includes a mount for receiving a removably couplable sleeve.

In certain cases, the mount is sized to receive one or more sleeves for adjusting the acoustic energy output from the first-sound-emitting opening. In some examples, the mount is sized to receive two or more distinct sleeves that have distinctions in at least one of size or mounting orientation.

In certain cases, at least one of the one or more sleeves is configured for use in two or more orientations.

In certain cases, the one or more sleeves enable adjustment of at least one of equalization or tuning of the acoustic energy output from the first-sound-emitting opening.

In certain cases, the headphone further includes a processor configured to adjust at least one of equalization or tuning in the acoustic energy output based on a type of sleeve coupled with the mount.

In certain cases, the type of sleeve is identified by at least one of an indicator on the sleeve or a user input. In some cases, the type of sleeve is identified by a user input received via a software application (or, app) on a connected device.

In certain cases, the processor is configured to split bands of the acoustic energy output.

In certain cases, the nozzle includes a flexible extension of the acoustic module.

In certain cases, the nozzle includes a pliable material that approximately maintains a shape after adjustment.

In certain cases, the nozzle includes a contoured shape configured to contact a portion of the user's ear proximate to the ear canal entrance.

In certain cases, the nozzle includes a compliant material configured to contact a portion of the user's ear proximate to the ear canal entrance.

In certain cases, the nozzle is formed of a material having a (shore) durometer of at least 10, e.g., a Shore A durometer of at least 10.0. In certain examples, the nozzle is formed of a plastic similar to a portion of the body, e.g., acrylonitrile butadiene styrene (ABS) plastic or polycarbonate.

In certain cases, the nozzle is configured to rotate relative to the body to adjust the direction of the acoustic energy output from the first sound-emitting opening.

In certain cases, the nozzle enhances active noise reduction (ANR) control of the acoustic energy output, e.g., relative to a headphone without the nozzle. For example, the nozzle can enhance sound output to the ear canal and enhance ANR control in one or more frequencies or frequency bands, e.g., at low frequencies and/or when louder ambient noise conditions exist.

In certain cases, the headphone further includes a second sound-emitting opening for acoustic venting.

In certain cases, the nozzle aids in controlling battery usage at the open-ear headphone by improving the sound pressure level (SPL) per volt output to the ear canal entrance.

In certain cases, the nozzle enhances a stable gain of the acoustic energy output when the open-ear headphone is used as a hearing assistance device.

In certain cases, the acoustic module and the nozzle define an asymmetric physical acoustic package.

In certain cases, the acoustic transducer is located in the nozzle.

In certain cases, the second portion includes a battery housing that houses a battery.

In certain cases, at least one of the anti-helix, the helix, or the lobule of the outer ear is configured to be located between the first portion and the second portion of the body.

In certain cases, the body is generally L-shaped, and the acoustic module and the body together are generally C-shaped.

In certain cases, the headphone further includes at least one microphone located in the acoustic module and/or the body.

Two or more features described in this disclosure, including those described in this summary section, may be combined to form implementations not specifically described herein.

The details of one or more implementations are set forth in the accompanying drawings and the description below. Other features, objects and benefits will be apparent from the description and drawings, and from the claims.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification, but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1 is a perspective view of an example headphone according to various implementations.

FIG. 2 is a perspective view of an additional example headphone along with nozzle sleeves according to various implementations.

FIG. 3 is a perspective view of an additional example headphone along with a nozzle sleeve according to various implementations.

FIG. 4 is a side view of an example headphone according to various additional implementations.

FIG. 5 is a schematic depiction of distinct headphones and output enhancement according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

Various disclosed implementations include an open-ear headphone (also referred to as an earphone or earbud) having an ear cuff that passes over the outer side of the antihelix, helix and/or lobule of a user's ear. The headphone includes an acoustic module configured to be located at least in part in a cavum conchae of an outer ear of a user, and a nozzle that includes an extension of the acoustic module for directing acoustic energy from a sound-emitting opening toward an ear canal entrance of the user. In certain cases, the headphone includes a mount for receiving one or more removably couplable sleeves. In further cases, the nozzle includes a flexible extension of the acoustic module.

In particular examples, the nozzle in the open-ear headphone can improve acoustic output to the ear canal entrance of the user. In certain cases, relative to conventional open-ear headphones (e.g., those without a nozzle) the open-ear headphone including the nozzle can increase low and mid frequency output to the ear canal entrance, e.g., output at approximately 500 hertz (Hz) or less (for low frequency) and approximately 500 Hz to approximately 2-3 kilo-Hz (for mid frequency). Further, the enhanced low to mid frequency output can improve the efficiency of the acoustic transducer, which can extend the battery life of the audio device. In certain examples, the open-ear headphone enhances the acoustic output of the transducer (e.g., as detectable at the ear canal entrance) by several decibels (dB) or more, e.g., approximately 2 dB, approximately 3 dB, approximately 4 dB, approximately 5 dB, approximately 6 dB or more.

Even further, relative to conventional headphones the disclosed open-ear headphone having an ear cuff enables enhanced comfort, retention, and/or acoustic performance. In some examples, the use of a nozzle with an ear cuff allows for distribution of the headphone's weight across distinct areas of the ear, enhancing comfort. In further examples, the ear cuff acts to stabilize the nozzle portion of the headphone to improve fit, retention, and/or acoustic performance. Further, relative to conventional open-ear headphones, the disclosed headphones can beneficially deliver sound to the user's ear canal region, improving audio quality, and/or mitigating detection of environmental noise.

These implementations may reduce manufacturing costs and/or complexity relative to conventional headphone headbands, among other benefits.

Commonly labeled components in the FIGURES are considered to be substantially equivalent components for the purposes of illustration, and redundant discussion of those components is omitted for clarity.

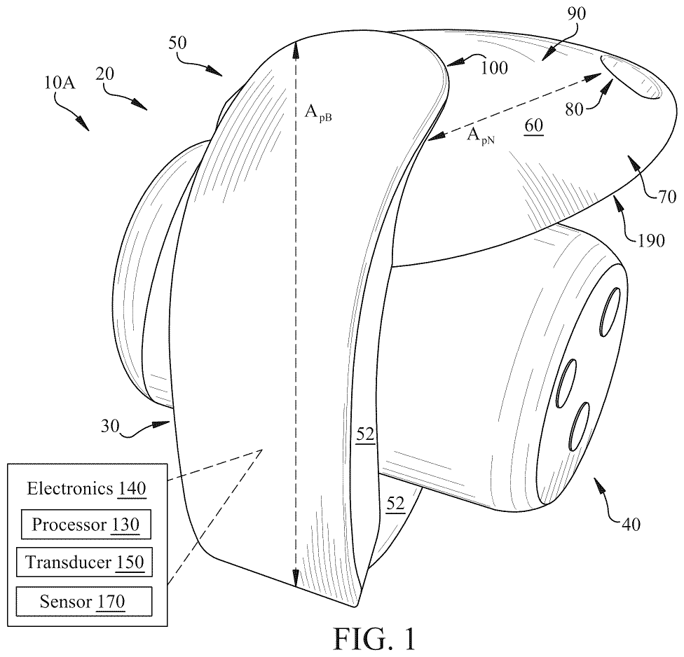

FIGS. 1-4 show perspective views of headphones 10 according to various implementations. Distinct implementations of the headphones 10 are denoted by “A,” “B,” “C,” and “D,” but various configurations include similar features. Certain reference to features common among headphones 10A, 10B, 10C, etc. is made to headphone 10. As noted herein, the headphone 10 includes an on-ear headphone that is configured to fit on a portion of a user's ear during wear. In certain cases, the headphone 10 includes at least one transducer (e.g., an electro-acoustic transducer) for providing an audio output, and in additional cases, at least one microphone. The headphone 10 can house various additional electronics as described herein. Further, electronics can be stored in various portions (or sections) of the headphone 10 depending on device configuration, usage, etc. In any case, the headphone 10 can be configured to mount on the user's ear and deliver an acoustic output to the region proximate the user's ear canal (e.g., ear canal entrance). Further, as noted herein, the headphone 10 is an open-ear headphone, that is, a headphone that does not obstruct the ear canal entrance of the user's ear.

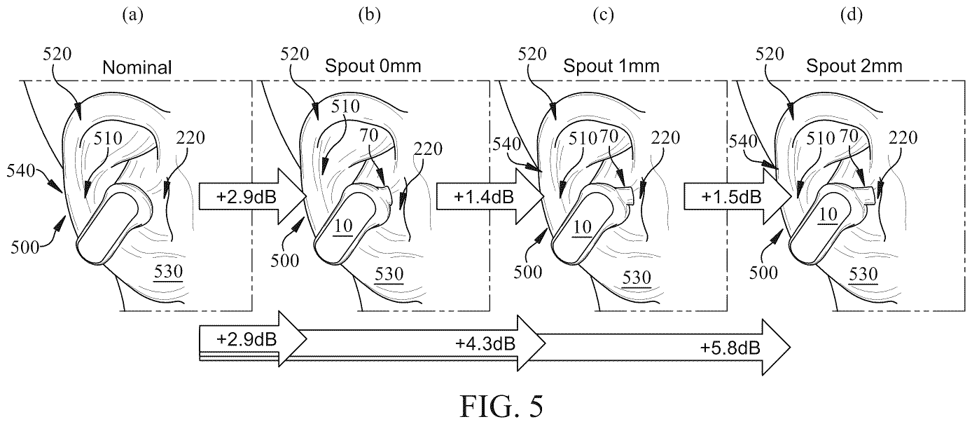

In particular cases, the headphone 10 includes a body 20 that includes a first portion 30 configured to pass over an outer side of at least one of an anti-helix, a helix, or a lobule of the outer ear. The body 20 further includes a second portion 40 configured to be located behind the outer ear. Variations of headphone 10 are shown in FIG. 5, which illustrates the outer side 500 of at least one of the antihelix 510, the helix 520, or the lobule 530 of the user's outer ear 540. In certain cases, the second portion 40 includes a battery housing that houses a battery. An acoustic module 50 is coupled to the body 20 and configured to be located at least in part in a cavum conchae of an outer ear 540 of the user. In an example, the body 20 is generally “L”-shaped and the acoustic module 50 and body 20 together (i.e., the first portion 30, second portion 40, and acoustic module 50) are generally “C”-shaped.

In some implementations, the ear cuff body 20 houses additional circuitry, such as conventionally found in a behind-the-ear (BTE) portion of a RIC hearing assistance device as incorporated by reference herein. For example, the body 20 can house a processor, a battery, one or more microphones, a communications module (e.g., a radio such as a BT radio), and memory (including instructions for controlling operations). As noted herein, one or more of the components or circuitry described as located in one portion of the audio device 10 can be located in another portion according to certain implementations.

In certain examples, to add compliance to body 20 and/or the acoustic module 50 such that it sits on the uneven surface of concavity, there may be a cushion or other compliant or compressible member 52 (FIG. 1) on all or part of body 20 and/or acoustic module 50, or these components can be made from a compliant material such as a foam. If light clamping of the headphone 10 to the ear is desirable, compliance can be built in. For example, at least first portion 30 or second portion 40 could be made of an elastomer or include a hinge element so that it can flex, thus altering the thickness of the gap between portions 30 and 40 that encompass ear portion. A suitable compliant elastomer may have a hardness of 80 durometer shore A, in one non-limiting example.

Generally, the outer ear (also known as the auricle or pinna) of a human includes a concha that is immediately adjacent to the entrance to the ear canal, which is underneath (or, behind) the tragus. The concha is divided by the helix crus into a lower portion termed the cavum conchae and an upper portion termed the cymba conchae. The cavum conchae is a generally bowl-shaped feature that is directly adjacent to the ear canal. The cavum conchae typically includes a depression bordered by the anti-tragus, which is the lower part of the anti-helix and/or bordered by the lobule. The lobule (i.e., the earlobe), which is at the lower end of the helix, is typically just below the anti-tragus. Additional description of ear anatomy is included, for example, in U.S. Pat. No. 11,140,469 (Open-Ear Headphone, issued Oct. 5, 2021), the entire contents of which are incorporated by reference.

In various implementations, the acoustic module 50 can include a transducer (e.g., internal to housing 60, not shown) and a nozzle 70 that has a first sound-emitting opening 80 for providing an audio output to the user's ear. The opening 80 is configured to be spaced from and proximate the user's ear canal opening, e.g., within approximately several millimeters (mm) to approximately two (2) centimeters of the user's ear canal opening. As similarly described with respect to headphones in U.S. Pat. No. 11,140,469 (previously incorporated by reference herein), the acoustic module 50 can further include a second opening, e.g., at another location, for acoustic venting.

In particular cases, such as illustrated in headphone 10A, the nozzle 70 is an extension 90 of the acoustic module 50, e.g., extending from the distal end 100 of the housing 60 of the acoustic module 50. The nozzle 70 can be configured to direct acoustic energy from the opening 80 toward and/or more proximate to an ear canal entrance of the user. In particular examples, the extension 90 is at least approximately 1 millimeter (mm) long, approximately 2 mm long, approximately 3 mm long, or approximately 4 mm long as measured from the distal end 100 of acoustic module 50. In particular implementations, the extension 90 is fixed (otherwise referred to as a fixed extension), and may be permanently set at a designated length, width, and/or angle. In other cases, as described herein, the extension 90 can be adjustable in at least one of length, width (or, diameter), and/or angle.

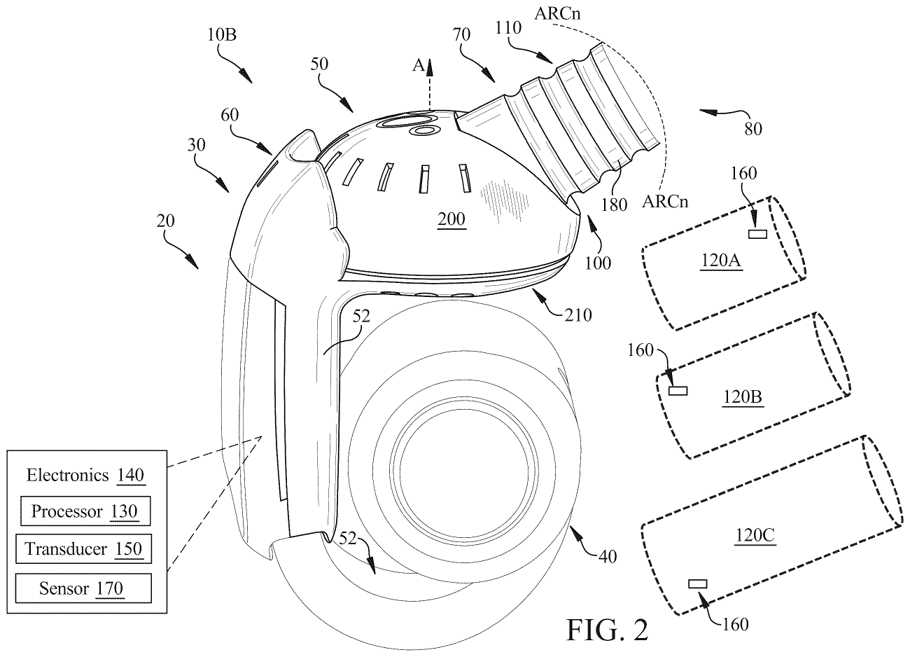

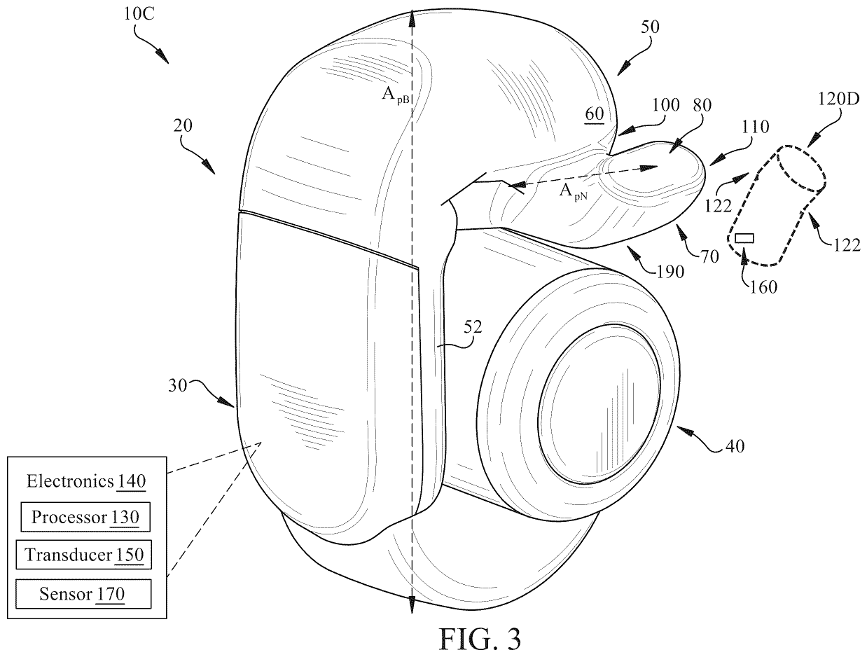

In certain cases, such as in headphone 10B and/or 10C, the nozzle 70 includes a mount 110 for receiving a removably couplable sleeve 120 (sleeve 120 shown separated from mount 110 in FIG. 2). In some cases, the mount 110 is sized to receive one or more sleeves 120A, 120B, 120C for adjusting the acoustic energy output from opening 80. For example, the mount 110 can be sized to receive two or more distinct sleeves (e.g., sleeves 120A, 120B, 120C, etc.) that have distinctions in size and/or mounting orientation. In certain cases, at least one sleeve (e.g., sleeve 120D, FIG. 3) is configured for use in two or more orientations, e.g., enabling fit adjustment. For example, a sleeve (e.g., sleeve 120D, FIG. 3) can include a curve, bend, or angle 122 that enables use in two or more orientations. In some cases, the distinct sizes of sleeves 120 and/or orientation of sleeves 120 enable adjustment of equalization and/or tuning of the acoustic energy output from the first opening 80. For example, distinct sleeve sizes 120 and/or sleeves 120 having distinct orientations can enable energy output with distinct equalization and/or tuning.

In particular implementations, as illustrated schematically in FIGS. 1-4, the headphone 10 can include a processor 130 (e.g., in electronics 140) in any portion of the housing. Electronics 140 can additionally include circuitry, sensors, audio components, communications components, power storage components, etc., not specifically denoted herein. Electronics 140 can also include one or more microphones, such as a feedforward and/or feedback microphone. In certain examples, the feedforward microphone can be used, for example, in active noise reduction (ANR) and/or active noise cancelation (ANC) functions by the headphone 10.

In certain examples, the processor 130 is configured to adjust equalization and/or tuning of the acoustic energy output from transducer 150 based on a type of sleeve 120 that is coupled with the mount 110. In certain cases the type of sleeve 120 is identified by an indicator 160 on the sleeve 120 and/or a user input (e.g., via an interface input). In some cases, the indicator 160 on the sleeve 120 includes a sleeve identifier such as an RFID tag, a capacitive indicator, etc. In particular cases, a sensor 170 at the headphone 10 (and connected with processor 130) is configured to detect the indicator 160 on the sleeve 120 and the processor 130 adjusts equalization and/or tuning of the acoustic energy output based on the identified sleeve 120 type. In additional or alternative cases, the type of sleeve 120 is identified by a user input received via a software application (or, app) on a connected device, e.g., a smart device such as a smartphone, tablet, smart watch, or computing device connected with headphone 10. In a particular implementation, the processor 130 is configured to split bands of the acoustic energy output in response to detecting a sleeve type. In further particular cases, the processor 130 is configured to adjust on-product signal processing such as equalization and/or limiters in response to detecting a sleeve, or a particular sleeve type. In certain examples, the addition of a sleeve (e.g., sleeve 120) may alter the acoustic frequency response such that the response below a threshold (e.g., approximately 3 kHz) is broadly increased, while being altered differently at higher frequencies. Accordingly, the processor 130 may beneficially adjust equalization and/or tuning of those frequency bands differently based on detecting the presence of a sleeve 120 and/or a type of sleeve 120.

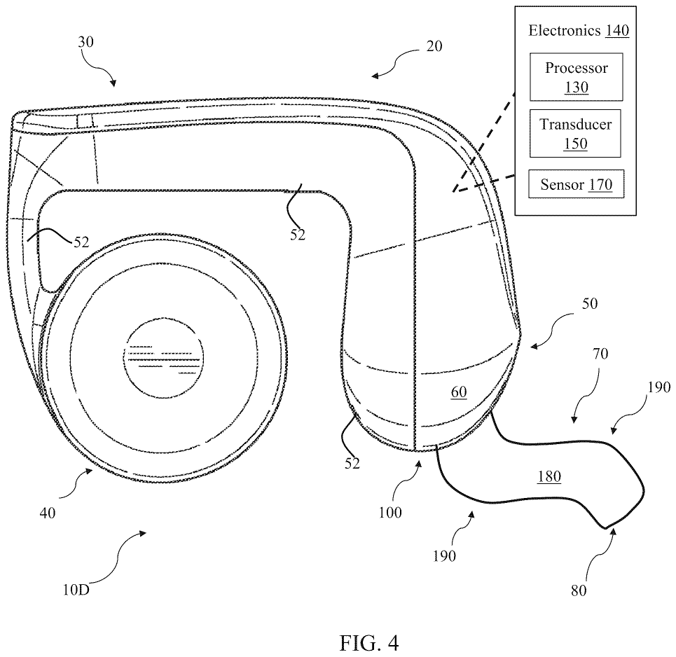

In further implementations, e.g., as shown in headphones 10B (FIGS. 2) and 10D (FIG. 4), the nozzle 70 can include a flexible extension 180 of the acoustic module 50. In these cases, the flexible extension 180 is configured to flex, or bend, to accommodate distinct output directions, fits, etc. In some cases, the nozzle 70 includes a pliable material that approximately maintains a shape after adjustment. Non-limiting examples of such pliable materials include thermoformed materials, etc.

In further implementations, e.g., as shown in headphones 10A, 10C, and 10D, the nozzle 70 can include a contoured shape that is configured to contact a portion of the user's ear proximate to the ear canal entrance. For example, a contour 190 can be configured to contact a portion of the user's ear proximate to the ear canal entrance. In certain cases, the contour 190 (and/or another contact point on the contoured shape) can beneficially enhance the fit of the headphone 10, and/or provide additional stability of the headphone 10 (e.g., as another point of contact with the ear).

In certain cases, the nozzle 70 includes a compliant material configured to contact a portion of the user's ear proximate to the ear canal entrance, e.g., at the contour 190 or at another location. According to some implementations, the nozzle 70 is formed of a material having a (Shore A) durometer of at least 10. In certain examples, the nozzle 70 is formed of a plastic similar to a portion of the body, e.g., acrylonitrile butadiene styrene (ABS) plastic or polycarbonate.

In still further implementations, e.g., in headphone 10B in FIG. 2, the nozzle 70 is configured to rotate relative to the body 60 to adjust the direction of the acoustic energy output from the first sound-emitting opening 80. For example, the nozzle 70 can include a rotatable base 200 that is coupled with a mount 210 on the acoustic module 50. In certain cases, the base 200 can be configured to rotate about axis (A), and nozzle 70 can be configured to pivot along an arc (ARCn).

As noted herein, the acoustic transducer(s) 150 providing the audio output via opening 80 can be positioned in a number of locations within the body of headphone 10. In particular cases, the transducer 150 is located in the second portion 30 of the body 20. In additional cases, the transducer 150 is located in the nozzle 70. In various particular cases, the acoustic module 50 and the nozzle 70 define an asymmetric physical acoustic package such that the nozzle 70 extends in a direction (e.g., axis A_{pN}) toward the ear canal entrance that is off-axis relative to an axis (A_{pB}) of the body 20, as shown in two non-limiting example configurations in FIGS. 1 and 3. In this sense, the outlet of nozzle 70 can be mis-aligned with the primary axis (A_{pN}) of the body 20, and in particular cases, can beneficially enhance performance by delivering audio output proximate the ear canal entrance 220 (FIG. 5). Further description and depiction of asymmetric output in a headphone is included for example, in U.S. patent application Ser. No. 17/590,321 (Open-Ear Headphone, filed Feb. 1, 2022), the entire contents of which are incorporated by reference herein.

In some aspects, the transducer 150 comprises a driver having a diameter less than approximately 12 millimeters (mm), and in more particular cases, a diameter less than approximately 5 mm. In certain examples, such as where the headphone 10 is used as a hearing assistance device, the transducer 150 can have a diameter of approximately 5 mm or less. In other examples, such as where the headphone 10 is not necessarily used as a hearing assistance device, the transducer 150 can have a diameter of approximately 12 mm or less.

In certain cases, the nozzle 70 enhances active noise reduction (ANR) control of the acoustic energy output, e.g., relative to a headphone without the nozzle 70. For example, the nozzle 70 can enhance sound output to the ear canal entrance and enhance ANR control in one or more frequencies or frequency bands, e.g., at low frequencies and/or when louder ambient noise conditions exist. For example, FIG. 5 shows an example comparison of acoustic output from open-ear headphone configurations (a), (b), (c), and (d) according to various implementations, including headphones 10 that include nozzles 70 of distinct lengths (as measured relative to a nominal length in (a)). As shown in the schematic comparison in FIG. 5, output can be gained by extending the length of nozzle 70 and placing the output of the nozzle closer to the ear canal entrance 220 (FIG. 5). In this non-limiting example, a nozzle 70 that is more than nominal but less than 1 mm in length provided an approximately 2.9 decibel (dB) improvement in output, while an additional 1 mm in length provided an approximately 1.4 dB improvement in output, and an additional 1 mm in length provided an approximately 1.5 dB improvement in output (for cumulative enhancement of approximately 5.8 dB for a 2+ mm nozzle 70 as measured from the nominal case (a).

As noted herein, the headphones 10 including nozzle 70 can provide various benefits relative to open-ear headphones. For example, the nozzle 70 can aid in controlling battery usage at the headphone 10 by improving the sound pressure level (SPL) per volt output to the ear canal entrance. Further, in some cases such as where the headphone 10 is used as a hearing assistance device, the nozzle 70 can enhance a stable gain of the acoustic energy output.

As also noted herein, various implementations of headphone 10 can beneficially enhance the user experience by, among other things, enhancing acoustic performance and/or fit relative to conventional open-ear headphones. For example, relative to open-ear headphones, the nozzle in the open-ear headphone can improve acoustic output to the ear canal entrance of the user. In certain cases, relative to conventional open-ear headphones (e.g., those without a nozzle) the open-ear headphone including the nozzle can increase low to mid frequency output to the ear canal entrance, e.g., output at approximately 500 hertz (Hz) or less (low) and/or output at approximately 500 Hz to approximately 2-3 kHz (mid). Further, the enhanced low frequency and/or mid-frequency output can improve the efficiency of the acoustic transducer, which can extend the battery life of the audio device. In certain examples, the open-ear headphone enhances the acoustic output of the transducer (e.g., as detectable at the ear canal entrance) by several decibels (dB) or more.

Even further, relative to conventional headphones, the disclosed open-ear headphone having an ear cuff enables enhanced comfort, retention, and/or acoustic performance. In some examples, the use of a nozzle with an ear cuff allows for distribution of the headphone's weight across distinct areas of the ear, enhancing comfort. In further examples, the ear cuff acts to stabilize the nozzle portion of the headphone to improve fit, retention, and/or acoustic performance. Further, relative to conventional open-ear headphones, the disclosed headphones can beneficially deliver sound to the user's ear canal region, improving audio quality, and/or mitigating detection of environmental noise.

As noted herein, the various disclosed headphones 10 can be configured for use as on-ear audio devices, i.e., providing a non-occluding fit.

The systems and methods disclosed herein may include or operate in, in some examples, headsets, headphones, hearing aids, or other personal audio devices, as well as acoustic noise reduction systems that may be applied in additional audio systems. Throughout this disclosure the terms “headset,” “headphone,” “earphone,” and “headphone set” are used interchangeably, and no distinction is meant to be made by the use of one term over another unless the context clearly indicates otherwise. Additionally, aspects and examples in accord with those disclosed herein are applicable to various form factors, such as in-ear transducers or earbuds and on-ear or over-ear headphones, and others.

Examples disclosed may be combined with other examples in any manner consistent with at least one of the principles disclosed herein, and references to “an example,” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

It is to be appreciated that examples of the methods and apparatuses discussed herein are not limited in application to the details of construction and the arrangement of components set forth in the following description or illustrated in the accompanying drawings. The methods and apparatuses are capable of implementation in other examples and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

For various components described herein, a designation of “a” or “b” in the reference numeral may be used to indicate “right” or “left” versions of one or more components. When no such designation is included, the description is without regard to the right or left and is equally applicable to either of the right or left, which is generally the case for the various examples described herein. Additionally, aspects and examples described herein are equally applicable to monaural or single-sided personal acoustic devices and do not necessarily require both of a right and left side.

Examples of the headphones described herein are not limited in application to the details of construction and the arrangement of components set forth in the following description or illustrated in the accompanying drawings. The headphones are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

In various implementations, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

The term “approximately” as used with respect to values herein can allot for a nominal variation from absolute values, e.g., of several percent or less. Unless expressly limited by its context, the term “signal” is used herein to indicate any of its ordinary meanings, including a state of a memory location (or set of memory locations) as expressed on a wire, bus, or other transmission medium. Unless expressly limited by its context, the term “generating” is used herein to indicate any of its ordinary meanings, such as computing or otherwise producing. Unless expressly limited by its context, the term “calculating” is used herein to indicate any of its ordinary meanings, such as computing, evaluating, smoothing, and/or selecting from a plurality of values. Unless expressly limited by its context, the term “obtaining” is used to indicate any of its ordinary meanings, such as calculating, deriving, receiving (e.g., from an external device), and/or retrieving (e.g., from an array of storage elements). Where the term “comprising” is used in the present description and claims, it does not exclude other elements or operations. The term “based on” (as in “A is based on B”) is used to indicate any of its ordinary meanings, including the cases (i) “based on at least” (e.g., “A is based on at least B”) and, if appropriate in the particular context, (ii) “equal to” (e.g., “A is equal to B”). Similarly, the term “in response to” is used to indicate any of its ordinary meanings, including “in response to at least.”

Unless indicated otherwise, any disclosure of an operation of an apparatus having a particular feature is also expressly intended to disclose a method having an analogous feature (and vice versa), and any disclosure of an operation of an apparatus according to a particular configuration is also expressly intended to disclose a method according to an analogous configuration (and vice versa). The term “configuration” may be used in reference to a method, apparatus, and/or system as indicated by its particular context. The terms “method,” “process,” “procedure,” and “technique” are used generically and interchangeably unless otherwise indicated by the particular context. The terms “apparatus” and “device” are also used generically and interchangeably unless otherwise indicated by the particular context. The terms “element” and “module” are typically used to indicate a portion of a greater configuration. Any incorporation by reference of a portion of a document shall also be understood to incorporate definitions of terms or variables that are referenced within the portion, where such definitions appear elsewhere in the document, as well as any figures referenced in the incorporated portion.

Other embodiments not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

Having described above several aspects of at least one example, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

We claim:

1. An open-ear headphone, comprising:
a body having:
a first portion configured to pass over an outer side of at least one of an anti-helix, a helix, or a lobule of the outer ear, and
a second portion configured to be located behind the outer ear; and
an acoustic module coupled to the body and configured to be located at least in part in a cavum conchae of an outer ear of a user, the acoustic module having an acoustic transducer and a nozzle including a first sound-emitting opening,
wherein the nozzle is an extension of the acoustic module that directs acoustic energy from the first sound-emitting opening toward an ear canal entrance of the user.

2. The open-ear headphone of claim 1, wherein the first sound-emitting opening is configured to be spaced from and proximate the user's ear canal opening.

3. The open-ear headphone of claim 1, wherein the nozzle includes a mount for receiving a removably couplable sleeve.

4. The open-ear headphone of claim 3 wherein the mount is sized to receive one or more sleeves for adjusting the acoustic energy output from the first-sound-emitting opening.

5. The open-ear headphone of claim 4, wherein at least one of the one or more sleeves is configured for use in two or more orientations.

6. The open-ear headphone of claim 4, wherein the one or more sleeves enable adjustment of at least one of equalization or tuning of the acoustic energy output from the first-sound-emitting opening.

7. The open-ear headphone of claim 6, further comprising a processor configured to adjust at least one of equalization or tuning in the acoustic energy output based on a type of sleeve coupled with the mount.

8. The open-ear headphone of claim 7, wherein the type of sleeve is identified by at least one of an indicator on the sleeve or a user input.

9. The open-ear headphone of claim 7, wherein the processor is configured to split bands of the acoustic energy output.

10. The open-ear headphone of claim 1, wherein the nozzle includes a flexible extension of the acoustic module, wherein the nozzle includes a pliable material that approximately maintains a shape after adjustment.

11. The open-ear headphone of claim 1, wherein the nozzle includes at least one of:
a) a contoured shape configured to contact a portion of the user's ear proximate to the ear canal entrance, or
b) a compliant material configured to contact a portion of the user's ear proximate to the ear canal entrance.

12. The open-ear headphone of claim 1, wherein the nozzle is formed of a material having a Shore A durometer of at least 10.

13. The open-ear headphone of claim 1, wherein the nozzle is configured to rotate relative to the body to adjust the direction of the acoustic energy output from the first sound-emitting opening.

14. The open-ear headphone of claim 1, wherein the nozzle enhances active noise reduction (ANR) control of the acoustic energy output.

15. The open-ear headphone of claim 1, wherein the nozzle:
a) aids in controlling battery usage at the open-ear headphone by improving the sound pressure level (SPL) per volt output to the ear canal entrance, and/or
b) enhances a stable gain of the acoustic energy output when the open-ear headphone is used as a hearing assistance device.

16. The open-ear headphone of claim 1, wherein the acoustic module and the nozzle define an asymmetric physical acoustic package such that an axis of the nozzle extends in a direction toward the ear canal entrance that is off-axis relative to an axis of the body.

17. The open-ear headphone of claim 1, wherein the acoustic transducer is located in the nozzle.

18. The open-ear headphone of claim 1, wherein the second portion includes a battery housing that houses a battery.

19. The open-ear headphone of claim 1, wherein at least one of the anti-helix, the helix, or the lobule of the outer ear is configured to be located between the first portion and the second portion of the body, wherein the body is generally L-shaped, and wherein the acoustic module and the body together are generally C-shaped.

20. The open-ear headphone of claim 1, further comprising at least one microphone located in the acoustic module and/or the body.
